(19) United States
(12) Patent Application Publication
(10) Pub. No.: US 2014/0019226 A1
(43) Pub. Date: Jan. 16, 2014

(54) SOCIAL NETWORK LIMITED OFFER DISTRIBUTION

(71) Applicant: Ezekiel Kruglick, Poway, CA (US)

(72) Inventor: Ezekiel Kruglick, Poway, CA (US)

(73) Assignee: EMPIRE TECHNOLOGY DEVELOPMENT LLC, Wilmington, DE (US)

(21) Appl. No.: 13/642,775

(22) PCT Filed: Jul. 10, 2012
(86) PCT No.: PCT/US2012/046022

§ 371 Date: Oct. 22, 2012

(51) Int. Cl. G06Q 50/00; G06Q 30/02

(52) U.S. Cl. CPC G06Q 50/01; G06Q 30/0239
USPC 705/14.39

(57) ABSTRACT

Technologies related to social network limited offer distribution are generally described. In some examples, a limited number of root participants may be allowed to claim an offer, and the offer may be limited to branch participants connected in a social network to the root participants and/or other branch participants in the limited offer. Participants in the limited offer and connections there between may be stored as a limited offer social network graph for use in subsequent marketing efforts. In the absence of social network graph information, participant contact information may be gathered and used to build a social network graph.

### BACKGROUND

Unless otherwise indicated herein, the materials described in this section are not prior art to the claims in this application and are not admitted to be prior art by inclusion in this section.

Marketing is, in some respects, an effort to understand and influence human decision making. Boyle, B., F. R Dwyer, R. A Robicheaux, and J. T Simpson, “Influence Strategies in Marketing Channels: Measures and Use in Different Relationship Structures,” Journal of Marketing Research (1992): 462-473 demonstrates that relationalism has the highest effectiveness at convincing people to undertake actions, followed by, in order of effectiveness, recommendations, information exchange, promises, requests, legalistic pleas, and threats. Also, as shown in Cialdini, “Influence: the Psychology of Persuasion,” Collins Business Essentials (1996), there is a “consistency effect” produced by public disclosure of people's own actions, such that people who have publicly done an action, such as a purchase, are more likely to do the action again, because they have demonstrated to others that they like it. Systems and services that can encourage relationalism in the form of social proof of purchasing decisions, recommendations, and the consistency effect, will likely increase customer interest, retention, and sales.

Presently available services such as GROUPON® and LIVINGSOCIAL® promote group buying in different ways and have shown success in promoting purchasing, while having detractors who say that customer retention and therefore value to merchants is low. Example services offered by GROUPON® attempt to inspire purchasing “events” by requiring a certain number of takers before a deal becomes valid. Example services offered by LIVINGSOCIAL® attempt to establish some level of social network promotion effects by offering deals free to people who get some number of friends to join in. These and other services attempt to leverage relationalism as a powerful marketing tool. However, there remains significant unexplored territory in developing systems and services that can effectively leverage powerful motivators such as relationalism in the form of social proof of purchasing decisions, recommendations, and the consistency effect.

### SUMMARY

The present disclosure generally describes technologies including devices, methods, and computer readable media relating to social network limited offer distribution. Some example methods may distribute limited offers using a social network graph. Example methods may include broadcasting a limited offer; receiving and accepting offer claims from root participants in response to the broadcasted limited offer; and/or limiting the limited offer to branch participants connected in the social network graph to the root participants and/or other branch participants in the limited offer.

The root participants may be limited according to any of a variety of rooting rules. For example, the root participants may comprise participants in a social network who are first to submit an offer claim to a limited total number of seed offers. In some embodiments, root participants may comprise participants in the social network who are at least a predefined number of connection steps apart in the social network graph from any other root participant and/or branch participant in the limited offer.

Limiting the offer may be achieved by performing operations in response to offer claims from interested branch participants. Such operations may include providing an interested branch participant identifier (ID) to a social network interface, such as an open graph Application Programming Interface (API); receiving, from the social network interface, social network graph information indicating connections between the interested branch participant and root participants and/or branch participants in the limited offer; accepting an offer claim from the interested branch participant when the social network graph information indicates a connection between the interested branch participant and at least one of the root participants and/or branch participants; and/or declining the offer claim from the interested branch participant when the social network graph information indicates no connection between the interested branch participant and the root participants and/or branch participants.

In some examples, the social network graph information may indicate a connection between the interested branch participant and a root participant and/or branch participant when the interested branch participant is equal to or less than a predefined number of connection steps apart from the root participant and/or branch participant in the social network graph. Conversely, the social network graph information may indicate no connection between the interested branch participant and the root participant and/or branch participant when the interested branch participant is greater than a predefined number of connection steps apart from the root participant and/or branch participant in the social network graph.

In some examples, the social network graph information may indicate potential branch participants linking the interested branch participant with root participant(s) and/or branch participant(s) in the limited offer, and methods may include identifying to the interested branch participant the potential branch participants linking the interested branch participant with the root participant(s) and/or branch participant(s). Methods may furthermore assist the interested branch participant in qualifying for the limited offer, e.g., by mediating a suggestion by the interested branch participant to a potential branch participant, to submit an offer claim to the limited offer, and/or mediating a connection request, by the interested branch participant to a root participant and/or branch participant in the limited offer, to establish a connection in the social network between the interested branch participant and a root and/or branch participant in the limited offer such that if the connection request is accepted, the interested branch participant would qualify for the limited offer.

In some examples, methods may include building and storing a “limited offer social network graph” comprising social network participant IDs and social network connection information used by social network participants to access the limited offer. The limited offer social network graph may then be used for subsequent offers and/or other marketing activities.

Some example methods may include building social network graphs. Example methods may comprise broadcasting a limited offer; receiving and accepting offer claims from root participants in response to the broadcasted limited offer; and/or limiting the limited offer to branch participants connected to the root participants and/or other branch participants while building a social network graph to determine connections between participants.

The root participants may be limited using rooting rules as described herein, for example, the root participants may comprise participants who are first to submit an offer claim to a limited total number of seed offers. In some embodiments, methods may also include requesting contact list information from the root participants and using the root participants' contact list information in building the social network graph. The root participants may optionally be limited to participants who are willing to share such contact list information for use in building the social network graph.

Limiting the offer may include performing operations in response to offer claims from interested branch participants. Example operations may comprise requesting contact list information from an interested branch participant; comparing received contact list information to root participants and/or branch participants; accepting the offer claim from the interested branch participant when the contact list information indicates a connection between the interested branch participant and a root participant and/or a branch participant; declining the offer claim from the interested branch participant when the contact list information indicates no connection between the interested branch participant the root participants or branch participants; and/or building and storing a social network graph using the received contact list information.

Methods directed to building a social network graph may also comprise aspects of the methods to distribute limited offers using social network graph information described above, such as identifying, to the interested branch participant, the potential branch participants linking the interested branch participant with the root participant; and/or assisting the interested branch participant in qualifying for the limited offer.

Computing devices and computer readable media having instructions implementing the various technologies described herein are also disclosed. Example computer readable media may comprise non-transitory computer readable storage media having computer executable instructions executable by a processor, the instructions that, when executed by the processor, cause the processor to carry out any combination of the various methods provided herein. Example computing devices may include a server comprising a processor, a memory, and a limited offer distribution system and/or social network graph builder system configured to carry out the methods described herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a schematic diagram illustrating example social network graph connections between root participants, branch participants, interested branch participants, and other participants;

FIG. 2 is a block diagram illustrating an example merchant computing device, participants, and social network computing device;

FIG. 3 is a block diagram illustrating an example merchant computing device, participants, and social network computing device;

FIG. 4 is a block diagram of a computing device as one example of a merchant computing device;

FIG. 5 is a flow diagram illustrating an example method configured to distribute limited offers using social network graph information; and

FIG. 6 is a flow diagram illustrating an example method configured to build a social network graph in connection with distributing limited offers using social network graph information;

all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure generally describes technologies including devices, methods, and computer readable media relating to social network limited offer distribution. In some examples, a limited number of root participants may be allowed to claim an offer, and the offer may be limited to branch participants connected in a social network to the root participants and/or other branch participants in the limited offer. Participants in the limited offer and connections there between may be stored as a limited offer social network graph for use in subsequent marketing efforts. In the absence of social network graph information, participant contact information may be gathered and used to build a social network graph.

Solutions according to this disclosure may generally make limited offers available to multiple participants, where the offers are limited by social network connections. Techniques to limit offers may leverage social network technologies to encourage relationalism and recommendation while maintaining a level of exclusivity in the ability of participants to access limited offers. Example processes may include broadcasting a limited offer, accepting a certain number of initial “root participants” in the limited offer, and then accepting additional “branch participants” in the limited offer by connection to the root participants and/or other branch participants. Root participants and branch participants are said to be “in” the limited offer when they have submitted offer claims that are received and accepted, e.g., a purchase has been made pursuant to the limited offer.

Variants of the disclosed embodiments may allow for more root participants when, for example, the root participants are widely separated in the social network. By leveraging social network graph information, disclosed techniques may encourage stronger customer ties and also may allow capturing limited offer social network graphs of participants who have connected purchasing influence and desires.

Solutions presented herein may allow limited offers to generate a feeling of exclusivity among participants, while being broadcast widely. By building networks of participant buyers, solutions herein may also leverage both relationalism and recommendation dynamics. Participants who ask their social network contacts to link them to a limited offer may be more committed themselves to a product, and may generate multiple reinforcing peer effects on other limited offer participants. Solutions herein may also provide advantages to social networks in launching group buying services, by allowing social networks to more effectively leverage the value of their social network graphs. In some embodiments, solutions herein may be leveraged by group buying services to build their own social network graphs.

An example group buying paradigm according to this disclosure may make limited offer buying opportunities available to participants with some defined level of connection to people who are already buying. Limited offers may be widely advertised but allowed to “nucleate” or “root” with some relatively lower number of initial root participants and after that, interested branch participant buyers may be shown how they are connected to existing root participant buyers. Interested branch participants may be prompted to request others to participate in limited offers to establish connections between themselves and current root participant buyers, so that interested branch participants may be branch-connected to root participant buyers and thus qualify for limited offers. Example benefits of such a group buying paradigm may include: the selling business gets a socially connected buying group in which many users have proclaimed their product interest to increase retention, group buying services get participants promoting limited offers to intermediate connections to achieve linkages which further reinforce relationalism in the form of social proof of desire for products, and social networks get a record of limited offer sub-networks of participants that share purchasing interests, as well as additional connections between social network participants.

In some embodiments, a limited offer may be first broadcast with limited root positions available, establishing both a wide audience and a feeling of exclusivity and urgency. The first N respondents may be accepted to form the root participants in the limited offer. Multiple strategy variations for accepting root participants may be employed. After the root participants are established, additional respondents, referred to herein as “interested branch participants”, may be informed of interconnection paths between themselves and those who have already claimed the limited offer.

When a first participant is directly connected to a second participant in a social network graph, the first and second participants may be considered to be, e.g., one connection step apart from each other in the social network graph. When the first participant is connected to an intermediate participant and the intermediate participant is connected to the second participant in the social network graph, the first and second participants may be considered to be two connection steps apart from each other in the social network graph. When the first participant is connected to the first intermediate participant, the first intermediate participant is connected to a second intermediate participant, and the second intermediate participant is connected to the second participant in the social network graph, the first and second participants may be considered to be three connection steps apart from each other in the social network graph. Number of connection steps in the social network graph may also be referred to herein as distance in the social network graph.

Interested branch participants within a defined social network distance to existing participants, e.g., within a distance equal to or less than a predetermined number of connection steps in the social network graph, to root and/or branch participants in the limited offer may be accepted for further participation, therefore building the limited offer social network graph. Disconnected interested branch participants may be motivated to request their social network contacts to join the limited offer so that they themselves may become connected to, and thereby qualify for, the limited offer. Such requests build a multiple influencer relationalism situation to increase sales and customer retention. Also, resulting limited offer social network graph information defines socially connected networks of customers that may be more durable and responsive to future offers.

In some embodiments, additional root participants may be accepted when the root participants are at least some predetermined number of connection steps apart from each other in the social network graph, e.g., equal to or greater than the predetermined number of connection steps apart. The predetermined number of connection steps may specify one, two, three, or any number of connection steps. This approach preserves a sense of exclusivity while potentially allowing larger numbers of people to participate. Alternately, in some embodiments, participants in limited offers may not count against a limited number of allowed root participants if the participants are branch connected in the social network graph to root participants. This approach may prevent limited offers from becoming caught in closed social groups.

In some embodiments, limited offers according to this disclosure may be useful in building interconnections between social network participants. For example the social network may suggest contacts to an interested branch participant at least in part for the purpose of helping the interested branch participant to qualify for the limited offer. The interested branch participant may possibly already know the suggested contacts and the availability of the limited offer may create an incentive to connect in the social network. The social network may also be able to use the interested branch participant's desire to qualify for a limited offer to induce the interested branch participant to make their email contacts available to heighten the probability of finding contacts who are root and/or branch participants in the limited offer. Social network graphs of root and branch participants in limited offers, referred to herein as limited offer social network graphs, may be retained for further marketing or may be retained by social networks for advertising with the knowledge that participants have made shared purchases before.

In some embodiments, a group buying system operator may offer sellers designing limited offers the ability to set or establish limited offer design variables, such as numbers of allowable root participants, acceptable separation distance (number of connection steps) in the social network graph between interested branch participants and root and/or branch participants to allow the interested branch participants to join the limited offer, and/or rooting rules for allowing root participants to qualify for the limited offer, such as total number of available root positions and/or predefined number of social network graph connection steps to a nearest existing root and/or branch participant.

Some embodiments may be implemented by social network providers such as FACEBOOK®, LINKEDIN®, XING®, RENREN®, or the like and may leverage existing social network graph information. Some embodiments may be implemented by group buying service providers in cooperation with a social network. For example, a group buying service may access a social network API to check linkages between interested branch participants and root participants. Some embodiments may allow group buying services to build social networks of their own, e.g., by inducing participants to share contact lists to get access to limited offers. In such embodiments rooting rules may for example be loose at first and more restrictive as time goes on and as social networks are built.

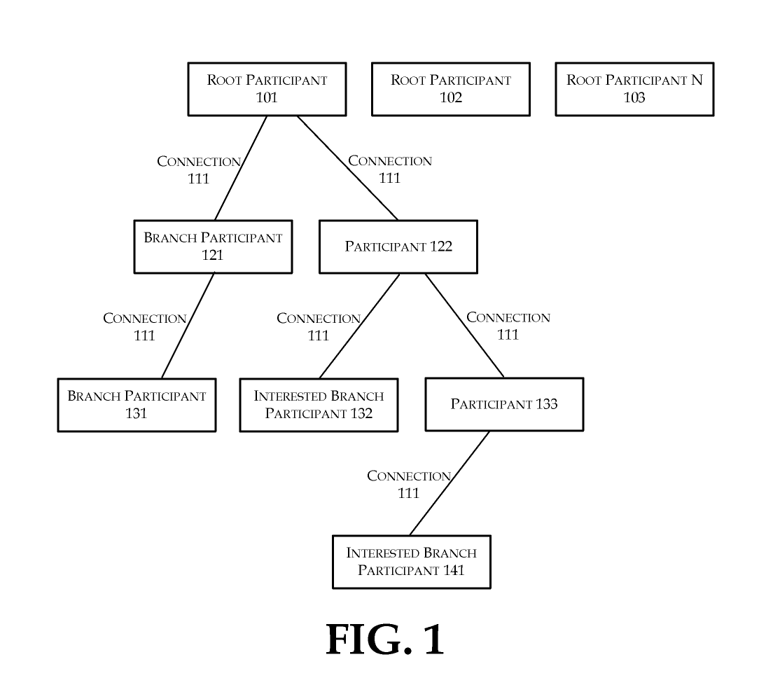

FIG. 1 is a schematic diagram illustrating example social network graph connections between root participants, branch participants, interested branch participants, and other participants, arranged in accordance with at least some embodiments of the present disclosure. FIG. 1 includes a root participant 101, a root participant 102, a root participant N 103, a branch participant 121, a participant 122, a branch participant 131, an interested branch participant 132, a participant 133, and an interested branch participant 141. Social network connections 111 are illustrated between root participant 101 and each of branch participant 121 and participant 122; between branch participant 121 and branch participant 131; between participant 122 and each of interested branch participant 132 and participant 133; and between participant 133 and interested branch participant 141.

In FIG. 1, the illustrated root participants, branch participants, interested branch participants, and participants may be referred to generally as participants, and the participants may be included in a social network. The social network may comprise the illustrated participants and connections 111, as well as numerous additional participants and connections as will be appreciated. A social network graph may include participant IDs and social network connections 111 between the participants.

In FIG. 1, a limited offer may be broadcast to, for example, the participants in the social network and/or the general public via any advertising media, including but not limited to television, print advertizing, internet advertizing and social media advertising. Targeted advertizing to a subset of participants in the social network and/or subsets of members of the general public, for example based on likely interest in the limited offer, is also considered a broadcast for purposes of this disclosure.

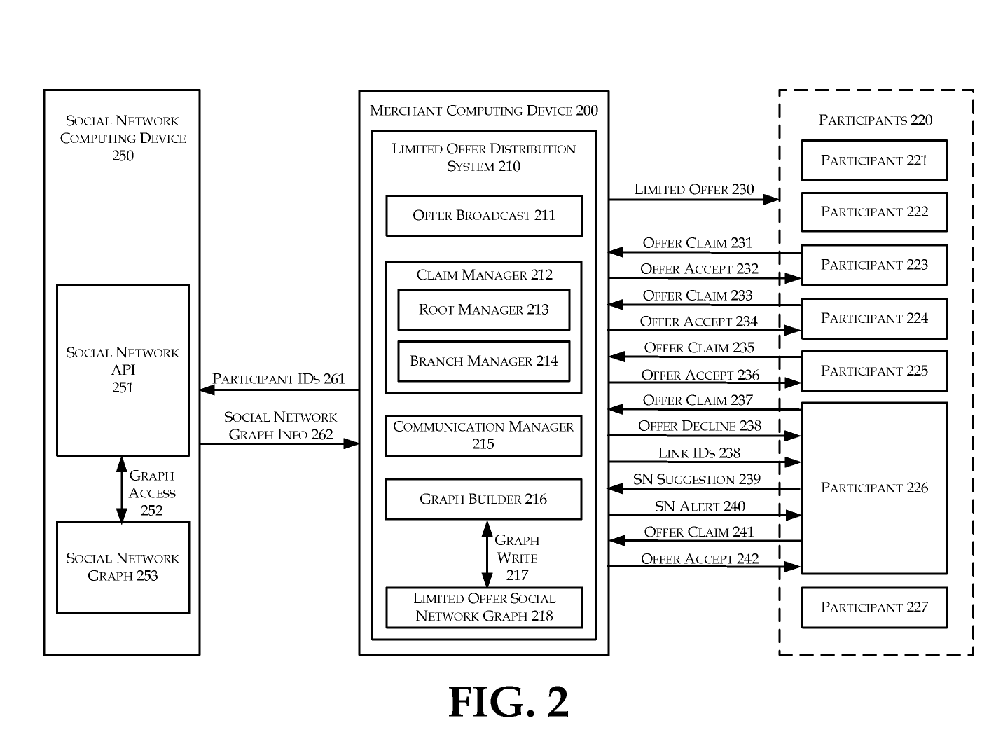

Some number of initial buyers in the social network illustrated in FIG. 1 may make offer claims to the broadcasted limited offer, which offer claims may be received and accepted for example by a merchant computing device 200 such as illustrated in FIG. 2, and some or all of the initial buyers may be designated as root participants 101, 102, 103 in the limited offer. The limited offer may limit root participants in any way, e.g., by allowing any limited total number (N) of root participants, and/or limiting a time window during which root participants may claim an offer, limiting minimum distance between root participants in the social network, limiting geographical locations of root participants, and any other approach for limiting root participants.

The limited offer may be limited to branch participants connected to root participants 101, 102, and 103 in the social network. For example, an offer claim from branch participant 121 may be accepted due to the existence of connection 111 between branch participant 121 and root participant 101. Once branch participant 121 has made a purchase, i.e., branch participant 121 has submitted an offer claim that is accepted, an offer claim from branch participant 131 may be accepted due to the existence of connection 111 between branch participant 131 and branch participant 121.

However, an offer claim from interested branch participant 132 may be declined when there is no connection between interested branch participant 132 and any of root participants 101, 102, 103, or branch participants 121, 131. Similarly, an offer claim from interested branch participant 141 may be declined, because there is no connection between interested branch participant 141 and any of root participants 101, 102, 103, or branch participants 121, 131.

Interested branch participants 132 and 141 may be provided with social network information to facilitate access the limited offer, e.g., interested branch participant 132 may be informed that participant 122 is a potential participant, that is, participant 122 is connected to root participant 101, and therefore participant 122 has access to the limited offer. Should participant 122 make an offer claim, such action would result in participant 122 being designated as a branch participant, and would allow interested branch participant 132 to also access the limited offer. Similarly, interested branch participant 141 may be informed that participant 122 is connected to root participant 101, and that participant 133 is connected to participant 122, and therefore participant 122 has access to the limited offer, which action would result in participant 122 being designated as a branch participant, and would allow participant 133 to also access the limited offer, which if claimed by participant 133, would in turn allow interested branch participant 141 to also access the limited offer.

In some embodiments, interested branch participants 132 and 141 may be given opportunities to form connections such as connections 111, between themselves and one or more of root participants 101, 102, 103 and branch participants 121, 131. Establishing connections between themselves and one or more of root participants 101, 102, 103 and/or branch participants 121, 131 may provide an avenue to for interested branch participants 132 and 141 to qualify for the limited offer.

It will be appreciated that in FIG. 1, connections 111 may comprise direct and/or indirect connections in a social network graph. In some embodiments, connections 111 may comprise direct connections only. In some embodiments, connections 111 may comprise indirect connections which may comprise for example connections that are equal to and/or less than a predefined number of connection steps through the social network graph.

FIG. 2 is a block diagram illustrating an example merchant computing device, participants, and social network computing device, arranged in accordance with at least some embodiments of the present disclosure. A merchant computing device 200 includes a limited offer distribution system 210. Limited offer distribution system 210 includes an offer broadcast component 211, a claim manager component 212, a communication manager component 215, a graph builder component 216 and a limited offer social network graph 218. Claim manager component 212 includes a root manager component 213 and a branch manager component 214. Participants 220 include participants 221-227. A social network computing device 250 includes a social network API 251 and a social network graph 253.

In FIG. 2, each of merchant computing device 200 and social network computing device 250 may comprise one or more computing devices implementing, for example, an ecommerce service and a social network service, respectively. In some embodiments, merchant computing device 200 may be operated by a social network operator and may be implemented as an element of one or more same devices as social network computing device 250. Conversely, social network computing device 250 may be operated by a merchant operator and may be implemented as an element of one or more same devices as merchant computing device 200. In some embodiments, merchant computing device 200 and social network computing device 250 may be operated by separate operators and may be communicatively coupled via wired or wireless network connections, which may include one or more computer networks including for example the Internet. In some embodiments, merchant computing device 200 may be operated by a group buying service such as GROUPON®. In some embodiments, merchant computing device 200 may be operated by a multi-merchant online shopping service such as AMAZON® or WALMART®. In some embodiments, merchant computing device 200 may be operated by a single merchant such as MICROSOFT®, APPLE®, DELL®, TOYOTA®, SPRINT®, or any other merchant.

Merchant computing device 200 and computing devices operated by participants 221-227 may be communicatively coupled via wired or wireless network connections including for example the Internet. Participants 221-227 may for example access a website supported by merchant computing device 200, which website may provide User Interfaces (UI) configured to implement the interactions between participants 221-227 and merchant computing device 200 described herein.

Participants 221-227 may also access the social network service associated with social network computing device 250. Such accesses are not illustrated in FIG. 2. Participants 221-227 may for example access the social network service to update their social network profiles, establish connections with one another, view advertisements for products, and/or perform any other activities pursuant to interacting with the social network service, as will be appreciated. Social network computing device 250 may be configured to store participant IDs in social network graph 253, along with data representing connections between participants 221-227 established in the social network service.

In FIG. 2, merchant computing device 200 may be configured to use offer broadcast component 211 to broadcast a limited offer 230 to participants 220. Participants 221, 222, and 227 may initially not submit offer claims. Participants 223, 224, 225, and 226 may submit offer claims 231, 233, 235, and 237, respectively, to merchant computing device 200. Participant 226 may also subsequently submit offer claim 241 to merchant computing device 200, as discussed further below. Merchant computing device 200 may be configured to receive offer claims 231, 233, 235, 237, and 241 and to pass received offer claims 231, 233, 235, 237, and 241 to limited offer distribution system 210 for processing.

Limited offer distribution system 210 may include claim manager 212 configured to determine whether root positions remain available for limited offer 230, and if so, to pass received offer claims 231, 233, 235, 237, and/or 241 to root manager 213 for processing. For example, when claim manager 212 receives offer claims 231 and 233, claim manager 212 may determine that root positions remain available for limited offer 230 and claim manager 212 may pass offer claims 231 and 233 to root manager 213.

Root manager 213 may be configured to determine whether to designate participants submitting offer claims as root participants. Root manager 213 may be configured to apply any rooting rules applicable to the limited offer to limit root participants. In some embodiments, rooting rules may allow a limited total number of seed offers, and root participants may comprise participants in the social network who are first to submit an offer claim to a seed offer. Root manager 213 may be configured to simply count accepted root participants, to accept additional root participants when additional root positions are available, and stop accepting additional root participants when additional root positions are no longer available.

In some embodiments, rooting rules may define at least a predefined number of connection steps between root participants and/or branch participants within social network graph 253. Root manager 213 may be configured to provide participant IDs 261 to social network API 251 to determine a number of connection steps between a potential root participant and other root participants and and/or branch participants in the limited offer. For example, root manager 213 may be configured to extract participant IDs for participants 223 and 224 from offer claims 231 and 233, and to provide extracted participant IDs as participant IDs 261 to social network API 251, along with a request for social network distance between participant IDs 261. Social network API 251 may return a number of connection steps between participants 223 and 224 in social network graph 253. Root manager 213 may be configured to determine whether the returned number of connection steps is sufficient to permit participant 223 and/or 224 to qualify as a root participant, based on applicable rooting rules.

Root manager 213 may be configured to apply rooting rules disclosed herein, combinations thereof, and/or any other rooting rules to limit root participants. Using applicable rooting rules, root manager 213 may for example designate participants 223 and 224 as root participants.

Claim manager 212 may be configured to accept offer claims based on designation of participants as root participants. For example, when participants 223 and 224 are designated as root participants, claim manager 212 may provide offer acceptances 232 and 234 to participants 223 and 224.

Claim manager 212 may be configured to limit participants allowed into limited offer 230 to branch participants connected in the social network to root participants and/or other branch participants in limited offer 230, by performing operations described herein in response to offer claims from interested branch participants. In some embodiments, claim manager 212 may be configured to pass received offer claims to branch manager 214 for processing when corresponding participants are not designated as root participants. For example, when claim manager 212 receives offer claims 235 and 237, claim manager 212 may be configured to determine that root positions are not available for participants 225 and 226, and claim manager 212 may be configured to pass offer claims 235 and 237 to branch manager 214 for processing.

Branch manager 214 may be configured to determine social network connections between interested branch participants and root participants. In some embodiments, branch manager 214 may be configured to cause merchant computing device 200 to pass participant IDs 261 associated with received offer claims to social network API 251. Participant IDs 261 in this context may comprise, for example, participant IDs corresponding to accepted root and branch participants in the limited offer 230 and participant IDs for interested branch participant(s) not designated as root or branch participants. For example, in response to receiving offer claim 235, branch manager 214 may pass to social network API 251 a participant ID for interested branch participant 225 along with participant IDs for root participants 223 and 224, as participant IDs 261. In response to receiving offer claim 237, branch manager 214 may pass to social network API 251 a participant ID for interested branch participant 226 along with participant IDs for root participants 223 and 224, as well as a participant ID for branch participant 225 (in the event that participant 225 is accepted into the limited offer prior to offer claim 237), as participant IDs 261. Participant IDs 261 may be accompanied by a request for connection information indicating connections, and in some embodiments, potential connections, between interested branch participant 226 and participants 223, 224, and/or 225. Potential connection information may for example comprise linking participants between interested branch participant 226 and participants 223, 224, and/or 225.

Social network API 251 may be configured to access social network graph 253 using one or more graph accesses 252 to determine social network connections between received participant IDs 261. In some embodiments, social network API 251 may comprise an open graph API, or similar type API such as currently used by some social network services. In some embodiments, social network API 251 may comprise any interface configured to provide access to social network graph 253. For example, when social network API 251 receives the participant ID for participant 225 along with participant IDs for root participants 223 and 224, social network API 251 may be configured to access social network graph 253 to determine connections between participant 225 and one or more of root participants 223 and 224. Social network API 251 may for example determine that participant 225 is connected to participant 223 in social network graph 253; however participant 225 is not connected to participant 224 in social network graph 253. Social network API 251 may be configured to return social network graph information 262 comprising connections between participant 225 and participants 223 and 224 to merchant computing device 200.

Furthermore, when social network API 251 receives the participant ID for interested branch participant 226 along with, for example, participant IDs for root participants 223 and 224, social network API 251 may be configured to access social network graph 253 to determine connections between interested branch participant 226 and one or more of root participants 223 and 224. Social network API 251 may for example determine that interested branch participant 226 is not connected to participant 223 or participant 224 in social network graph 253; however interested branch participant 226 is connected to potential participant 221 in social network graph 253 and potential participant 221 is in turn connected to participant 224 in social network graph 253. Social network API 251 may be configured to return social network graph information 262 comprising connections between participant 226 and participants 223 and 224, or connections between participant 226 and potential participants such participant 221, to merchant computing device 200.

Claim manager 212 may be configured to accept or deny received offer claims in response to received social network graph information 262. Claim manager 212 may be configured to accept offer claims from interested branch participants when social network graph information 262 indicates a connection between the interested branch participants and at least one root participant. Claim manager 212 may be configured to decline offer claims from interested branch participants when social network graph information 262 indicates no connection between the interested branch participants and the root participants. For example, claim manager 212 may accept offer claim 235 and may accordingly provide an offer acceptance 236 to participant 225, due to the connection between participant 225 and root participant 223 in social network graph 253. Claim manager 212 may decline offer claim 237 and may accordingly provide an offer decline 238 to interested branch participant 226, due to the absence of connections between interested branch participant 226 and root participants 223 and 224 in social network graph 253.

Claim manager 212 may be configured to provide linking participant IDs, referred to as link IDs 238, indicating one or more potential branch participants linking interested branch participant 226 with a root participant. For example, when social network graph information 262 indicates that interested branch participant 226 is connected to potential branch participant 221, and potential branch participant 221 is in turn connected to root participant 224 in social network graph 253, a link ID for potential branch participant 221 may be provided in link IDs 238 to interested branch participant 226. Interested branch participant 226 may then contact potential participant 221 directly to suggest that potential participant 221 participates in limited offer 230.

In some embodiments, limited offer distribution system 210 may include a communication manager 215 configured to mediate suggestions, by interested branch participants to potential branch participants, to submit an offer claim to limited offer 230. Interested branch participant 226 may for example provide a social network suggestion 239 to merchant computing device 200. Communication manager 215 may forward social network suggestion 239 to potential participant 221, to indicate that interested branch participant 226 wants to participate in limited offer 230 and would have access to limited offer 230 if potential participant 221 were to submit an offer claim. Communication manager 215 may be configured to provide a social network alert 240 to interested participant in the event that potential participant 221 submits an offer claim, therefore giving interested branch participant 226 access to limited offer 230. In some embodiments, communication manager 215 may be configured to provide social network alert 240 in the event that interested branch participant 226 qualifies for limited offer by any avenue, e.g., in the event that any contact of interested branch participant 226 participates in limited offer 230, regardless of whether interested branch participant 226 suggested participation.

In some embodiments, communication manager 215 may be configured to mediate connection requests, by interested branch participants to root participants and/or potential branch participants, linking interested branch participants with root participants to establish connections in the social network. For example, social network suggestion 239 may comprise a suggestion that root participant 224 accept establishing a social network connection between root participant 224 and interested branch participant 226. Communication manager 215 may be configured to suggest to root participant 224 that root participant 224 may connect with interested branch participant 226 in the social network to allow interested branch participant 226 to qualify for limited offer 230.

Interested branch participant 226 may submit a subsequent offer claim 241 at any time after initial offer claim 237 is declined. Offer claim 241 may be received and processed as described above. Should interested branch participant 226 qualify for limited offer 230, e.g., by potential participant 221 submitting an offer claim (not shown) which is accepted, so that participant 221 becomes a branch participant, then claim manager 212 may accept offer claim 241 and may provide offer acceptance 242 to interested branch participant 226 as shown. Should interested branch participant 226 not qualify for limited offer 230, then offer claim 241 may be again declined as described above.

In some embodiments, graph builder 216 may be configured to store limited offer social network graph 218 comprising social network participant IDs and social network connection information used by social network participants to access limited offer 230. For example, graph builder 216 may use social network graph information 262 to perform graph writes 217 to include participant IDs for each participant associated with an accepted offer claim, and to include connection information indicating connections that qualified participants for limited offer 230. Thus graph builder 216 may for example identify root participants 223 and 224, branch participant 225 and branch participant 225′s connection to root participant 223, branch participant 221 (assuming participant 221 submits an accepted offer claim as described in connection with this example) and branch participant 221′s connection to root participant 224, and branch participant 226 (assuming participant 226 ultimately submits an accepted offer claim as described in connection with this example) and branch participant 226′s connection to branch participant 221. Limited offer social network graph 218 may be useful for subsequent marketing activities, e.g., for offers similar to limited offer 230.

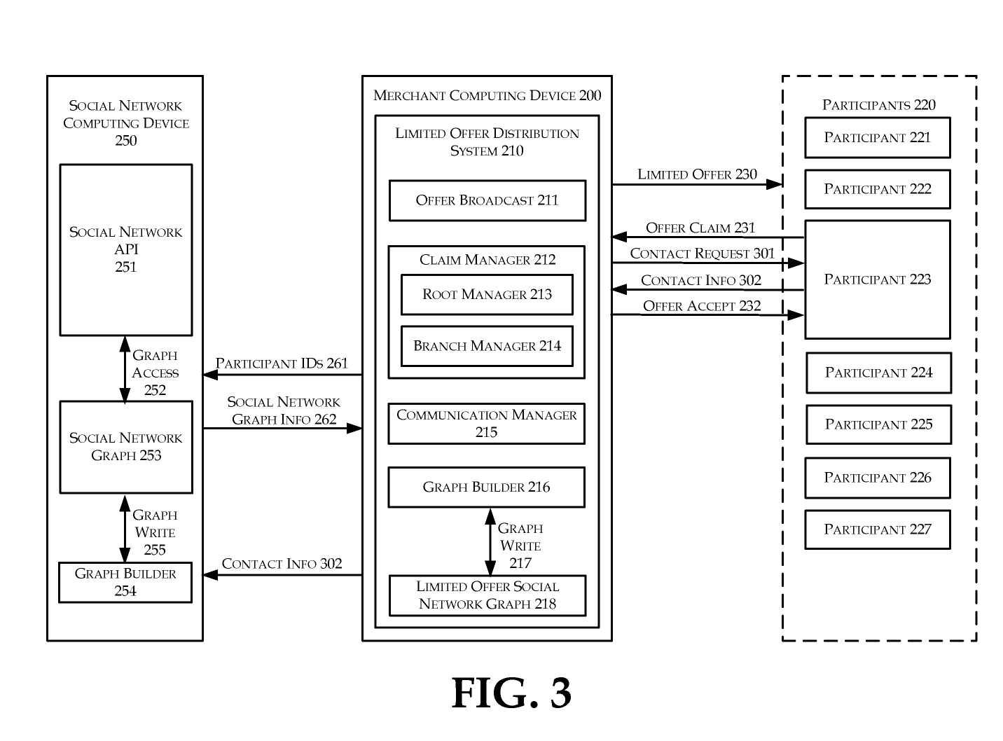

FIG. 3 is a block diagram illustrating an example merchant computing device, participants, and social network computing device, arranged in accordance with at least some embodiments of the present disclosure. FIG. 3 includes the depicted elements of FIG. 2, with like components assigned like identifiers. Additionally, social network computing device 250 includes a graph builder 254. Embodiments according to FIG. 3 may also comprise interactions between merchant computing device 200, participants 220, and social network computing device 250 as illustrated in FIG. 2, with the addition of interactions relating to building social network graph 253 using received participant contact information, as described herein.

In FIG. 3, limited offer distribution system 210 may be configured to provide contact requests to participants 220, in connection with offer claims. For example, limited offer distribution system 210 may be configured to provide contact request 301 to participant 223 in response to offer claim 231. Limited offer distribution system 210 may be configured to receive contact information 302, e.g., a list of email contacts including for example names, email addresses, telephone numbers, and/or physical addresses stored in a participant email account. Limited offer distribution system 210 may be configured to build and store social network graph 253 using received contact list information 302, e.g., by providing contact information 302 to graph builder 254 in social network computing device 250. Graph builder 254 may be configured to build and store social network graph 253 by performing graph write operations 255 on social network graph 253, for example, comparing names and/or emails of contacts in received contact information 302 with names and/or emails in social network graph 253, adding new participant IDs for contacts in social network graph 253 when not already present, and including connection information connecting participants in social network graph 253 with participant 223, according to received contact information 302.

In some embodiments according to FIG. 2 and/or FIG. 3, the components of social network computing device 250 may be included in merchant computing device 200, and vice-versa. For example, in some embodiments, a merchant may use embodiments according to FIG. 3 to build a social network graph, bypassing need for a pre-existing social network in order to implement limited offer distribution as described herein. Instead of accessing social network graph 253 via social network API 253, embodiments may compare received contact information 302 to root participants and/or branch participants in limited offer 230; accept offer claim 231 from an interested branch participant, e.g., from participant 223 in an example scenario in which participant 223 is an interested branch participant instead of a root participant as in the example described in connection with FIG. 2, when the contact information 302 indicates a connection between interested branch participant 223 and at least one root participant and/or branch participant; and/or decline offer claim 231 from interested branch participant 223 when contact information 302 indicates no connection between interested branch participant 223 root participants and/or branch participants in limited offer 230.

In some embodiments, contact requests may be sent to root participants and/or interested branch participants, as a condition to participate in limited offer 230. For example, in some embodiments, a rooting rule may specify that in order to qualify as a root participant, participant 223 must provide contact information 302. In some embodiments, root participants may not be required to provide contact information however interested branch participants may be required to provide contact information. In some embodiments, root participants and interested branch participants that are already connected to a root and/or branch participant in limited offer 230, as observed in social network graph 253, may not be required to provide contact information, however interested branch participants that are not already connected to a root and/or branch participant in limited offer 230 may be required to provide contact information.

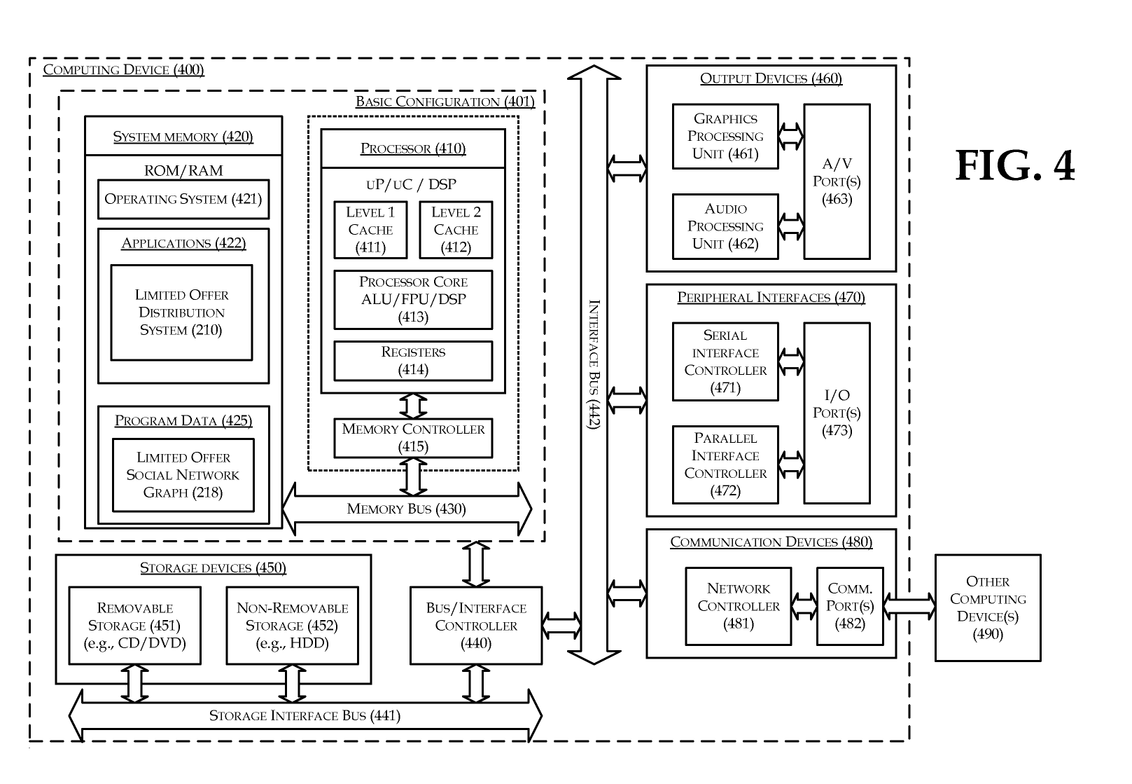

FIG. 4 is a block diagram of a computing device as one example of a merchant computing device, arranged in accordance with at least some embodiments of the present disclosure. In a very basic configuration 401, computing device 400 may include one or more processors 410 and a system memory 420. A memory bus 430 may be used for communicating between processor 410 and system memory 420.

Depending on the desired configuration, processor 410 may be of any type including but not limited to a microprocessor (μP), a microcontroller (μC), a digital signal processor (DSP), or any combination thereof. Processor 410 may include one or more levels of caching, such as a level one cache 411 and a level two cache 412, a processor core 413, and registers 414. Processor core 413 may include an arithmetic logic unit (ALU), a floating point unit (FPU), a digital signal processing core (DSP Core), or any combination thereof. A memory controller 415 may also be used with processor 410, or in some implementations memory controller 415 may be an internal part of processor 410.

Depending on the desired configuration, system memory 420 may be of any type including but not limited to volatile memory (such as RAM), non-volatile memory (such as ROM, flash memory, etc.), or any combination thereof. System memory 420 typically includes an operating system 421, one or more applications 422, and program data 425. In some embodiments, operating system 421 may comprise a virtual machine that is managed by a Virtual Machine Manager (VMM). Applications 422 may include, for example, limited offer distribution system module(s) 210, such as those illustrated in FIG. 2 and FIG. 3. Program data 325 may include limited offer social network graph data 218 and any other data that may be used by applications 422. In embodiments in which computing device 400 provides functions of merchant computing device 200 and social network computing device 250, applications 422 may furthermore include social network API module(s) 251 and/or graph builder module(s) 254, and program data 325 may include social network graph data 253.

Computing device 400 may have additional features or functionality, and additional interfaces to facilitate communications between the basic configuration 401 and any required devices and interfaces. For example, a bus/interface controller 440 may be used to facilitate communications between the basic configuration 401 and one or more data storage devices 450 via a storage interface bus 441. The data storage devices 450 may be removable storage devices 451, non-removable storage devices 252, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable and non-removable media implemented in any method or technology for storage of information, such as computer readable instructions, data structures, program modules, or other data.

Level 1 cache 411, level 2 cache 411, system memory 420, removable storage 451, and non-removable storage devices 252 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 400. Any such computer storage media may be part of device 400.

Computing device 400 may also include an interface bus 442 for facilitating communication from various interface devices (e.g., output interfaces, peripheral interfaces, and communication interfaces) to the basic configuration 401 via the bus/interface controller 440. Example output devices 460 include a graphics processing unit 461 and an audio processing unit 462, which may be configured to communicate to various external devices such as a display or speakers via one or more AN ports 463. Example peripheral interfaces 470 may include a serial interface controller 471 or a parallel interface controller 472, which may be configured to communicate through either wired or wireless connections with external devices such as input devices (e.g., keyboard, mouse, pen, voice input device, touch input device, etc.) or other peripheral devices (e.g., printer, scanner, etc.) via one or more I/O ports 473. Other conventional I/O devices may be connected as well such as a mouse, keyboard, and so forth. An example communications device 480 includes a network controller 481, which may be arranged to facilitate communications with one or more other computing devices 490 over a network communication via one or more communication ports 482.

The computer storage media may be one example of a communication media. Communication media may typically be embodied by computer readable instructions, data structures, program modules, or other data in a modulated data signal, such as a carrier wave or other transport mechanism, and include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media.

Computing device 400 may be implemented as an ecommerce server and/or a social network server. In some embodiments, computing device 400 may comprise a server in a data center which is managed by a data center operator according to the specifications of a merchant or data center operator. Computing device 400 may also be implemented as a business use computer including both laptop computer and non-laptop computer configurations.

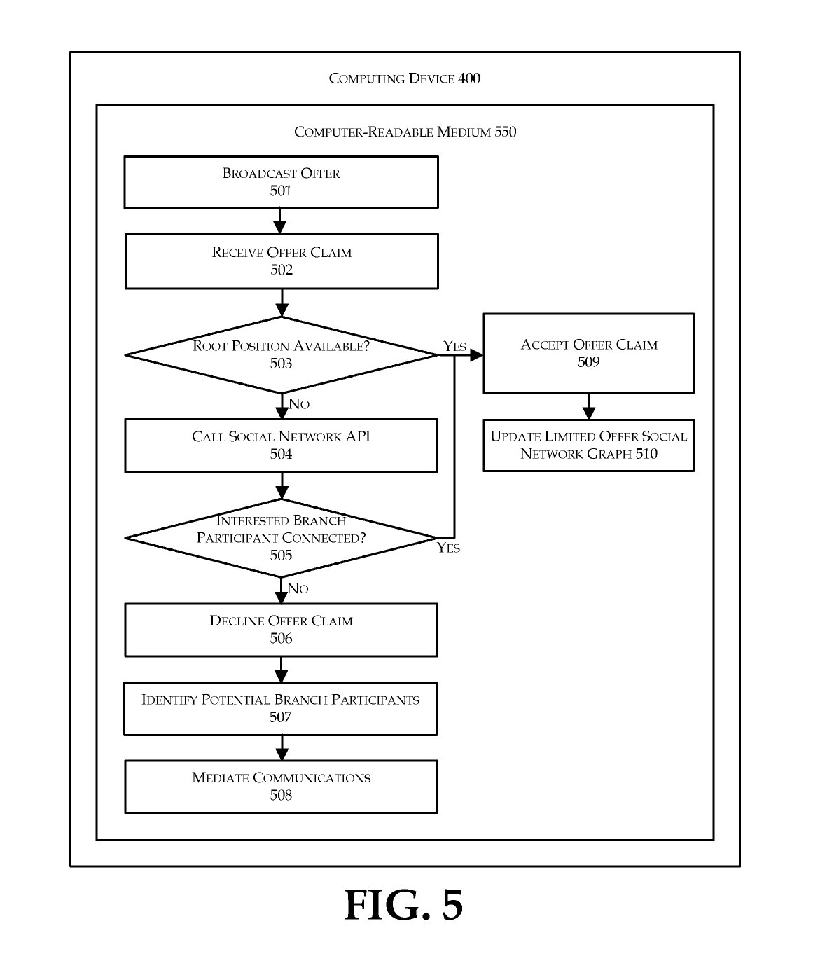

FIG. 5 is a flow diagram illustrating an example method configured to distribute limited offers using social network graph information, arranged in accordance with at least some embodiments of the present disclosure. The example flow diagram may include one or more operations/modules as illustrated by blocks 501-510, which represent operations as may be performed in a method, functional modules in a computing device 400 equipped with a limited offer distribution system such as illustrated in FIG. 4, and/or instructions as may be recorded on a computer readable medium 550. The illustrated blocks 501-510 may be arranged to provide functional operations of “Broadcast Offer” at block 501, “Receive Offer Claim” at block 502, “Root Position Available?” at decision block 503, “Call Social Network API” at block 504, “Interested Branch Participant Connected?” at decision block 505, “Decline Offer Claim” at block 506, “Identify Potential Branch Participants” at block 507,” “Mediate Communications” at block 508, “Accept Offer Claim” at block 509, and “Update Limited Offer Social Network Graph” at block 510.

In FIG. 5, blocks 501-510 are illustrated as including blocks being performed sequentially, e.g., with block 501 first and block 510 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 5 illustrates an example method by which computing device 400 may distribute limited offers using social network graph information. Offers may be limited by limiting root participants, and determining whether to accept or decline offer claims from interested branch participants based on social network connections to other limited offer participants.

In a “Broadcast Offer” block 501, computing device 400 may make a limited offer available to social network participants. Computing device 400 may for example publish the limited offer on a website, email the limited offer to a set of subscribers, or otherwise advertise the limited offer. In some embodiments, the limited offer may be broadcast to the general public. In some embodiments, the limited offer may be broadcast using targeted advertizing techniques, e.g., by displaying an advertisement to social network participants based on likely interests and activities of the social network participants. Broadcasted information describing terms by which the limited offer is limited, e.g., that limited root participants may be accepted, and that the offer may be limited to branch participants connected to the limited root participants and/or other branch participants in a social network, may or may not be broadcast along with the limited offer. Block 501 may be followed by block 502.

In a “Receive Offer Claim” block 502, computing device 400 may receive an offer claim to the broadcast limited offer. Computing device 400 may receive the offer claim, e.g. via a website UI provided by computing device 400, or by any other means, such as by email, telephone call, and/or data entry by a store clerk who may for example interact in person with a participant submitting the offer claim. The offer claim may include a social network participant ID, such as a username or other identifier allowing identification of a person submitting the offer claim in a social network service, and a limited offer ID. Block 502 may be followed by decision block 503.

In a “Root Position Available?” decision block 503, computing device 400 may determine whether the received offer claim qualifies for a root position in the limited offer. Computing device 400 may compare information in the offer claim against rooting rules established for the limited offer. For example, rooting rules may define that root participants are participants in a social network, that root participants comprise participants in the social network who are first to submit an offer claim to a limited total number of “seed offers” corresponding to a limited total number of root positions, and/or that root participants comprise participants in the social network who are at least a predefined number of connection steps apart from any other root participant and/or branch participant within a social network graph. Computing device 400 may call a social network API to determine number of connection steps. Decision block 503 may be followed by block 509 when a root position is available or by block 504 when no root position is available.

Computing device 400 may perform blocks 504, 505, 506 and/or 509 to limit the limited offer to branch participants connected to root participants and/or other branch participants in the social network. In a “Call Social Network API” block 504, computing device 400 may provide an interested branch participant ID associated with the received offer claim to a social network API. In some embodiments, computing device 400 may also provide IDs for root participants and/or other branch participants to the social network API. In some embodiments, computing device 400 may also provide a predefined number of connection steps between participants, e.g. specifying direct connection (e.g. 1 connection step) between participants and/or indirect connection between participants along with a predefined number of allowable connection steps (e.g., two or more connection steps) in a social network graph.

In block 504, computing device 400 may also receive, from the social network API, social network graph information indicating connections between the interested branch participant and the root participants. In some embodiments, the social network API may return a “yes” or “no” response indicating whether the interested branch participant is connected to the root participants and/or other branch participants. In some embodiments, the social network API may return IDs of other social network participants—referred to herein as “potential” branch participants, connecting the interested branch participant with the root participants and/or other branch participants in the limited offer. Block 504 may be followed by decision block 505.

In an “Interested Branch Participant Connected?” decision block 505, computing device 400 may process received social network graph information to determine whether the interested branch participant associated with the received offer claim is connected to the root participants and/or other branch participants in the limited offer. For example, when the received social network graph information from block 504 indicates “yes”, the interested branch participant may be treated as connected and therefore qualifying for the limited offer, and decision block 505 may be followed by block 509. When the received social network graph information from block 504 indicates “no”, the interested branch participant may be treated as not connected and therefore not qualifying for the limited offer, and decision block 505 may be followed by block 506.

In embodiments comprising limited offers allowing indirect connections between participants, computing device 400 may evaluate whether received social network graph information indicates a connection between the interested branch participant and root participants and/or branch participants. For example, when the interested branch participant is equal to or less than a predefined number of connection steps apart from the root participant and/or branch participants in the social network graph, the interested branch participant may be treated as connected and therefore qualifying for the limited offer, and decision block 505 may be followed by block 509. When the interested branch participant is greater than the predefined number of connection steps apart from the root participant in the social network graph, the interested branch participant may be treated as not connected and therefore not qualifying for the limited offer, and decision block 505 may be followed by block 506.

In a “Decline Offer Claim” block 506, computing device 400 may decline the offer claim from the interested branch participant when the social network graph information indicates no connection between the interested branch participant and the root participants and/or branch participants in the limited offer. Declining the offer claim may for example comprise avoiding and/or preventing a transaction in which the interested branch participant may make a purchase of goods or services offered according to the limited offer. For example, a social network username and password may be employed to access UI configured to process a transaction under the limited offer. Computing device 400 may not provide the transaction UI unless a qualifying username and password are entered. In some embodiments, computing device 400 may inform the interested branch participant via a website UI, email, or any other communication method that the interested branch participant does not qualify for the limited offer, and may provide another offer or redirection. Block 506 may be followed by block 507.

In an “Identify Potential Branch Participants” block 507, when received social network graph information indicates one or more potential branch participants linking the interested branch participant with the root participants and/or branch participants in the limited offer, computing device 400 may identify, to the interested branch participant in response to the offer claim from the interested branch participant, the potential branch participants linking the interested branch participant with the root participants and/or branch participants. Computing device 400 may identify root participants and/or branch participants for example in a same website UI which informs the interested branch participant that the offer claim is declined. Computing device 400 may otherwise identify root participants and/or branch participants by any communication method, such as by website UI, email, or otherwise. By identifying potential branch participants, computing device 400 may help the interested branch participant to take action to qualify for the limited offer, such as by asking a potential branch participant to participate in the limited offer, and/or connecting to root participants and/or branch participants already participating in the limited offer. Block 507 may be followed by block 508.

In a “Mediate Communications” block 508, in some embodiments computing device 400 may mediate a suggestion, by the interested branch participant to the one or more potential branch participants, to submit an offer claim to the limited offer. In some embodiments computing device 400 may mediate a connection request, by the interested branch participant to one or more of a root participant and/or a potential branch participant linking the interested branch participant with a root participant, to establish a connection in the social network. Computing device 400 may for example mediate suggestions by communicating with social network participants, within a social network communication channel such as a social network status update, journal entry, private email and/or chat, on behalf of the interested branch participant. In some embodiments, computing device 400 may mediate suggestions by any communications channel including email and/or telephone. In some embodiments, computing device 400 may also be configured to notify the interested branch participant in the event of participation in the limited offer by a potential branch participant, which participation allows the interested branch participant to qualify for the limited offer. In some embodiments, computing device 400 may be configured to manage additional communications, e.g., notifying root and/or branch participants each time an additional interested branch participant qualifies for the limited offer based on their connection to the root and/or branch participants. Blocks 507 and/or 508 may be followed by the interested branch participant submitting another offer claim, which may be received by block 502 and processed as described above.

In an “Accept Offer Claim” block 509, computing device 400 may accept an offer claim when a root position was determined to be available in decision block 503 and/or it was determined that an interested branch participant is connected in decision block 505 (e.g., when social network graph information indicates a connection between the interested branch participant and the root participants and/or branch participants in the limited offer). Computing device 400 may accept the offer claim for example by providing transaction UI allowing completion of a purchase according to the limited offer. Computing device 400 may accept the offer claim by other communication methods, e.g., email and/or telephone call. Block 509 may be followed by block 510.

In an “Update Limited Offer Social Network Graph” block 510, computing device 400 may store and update a limited offer social network graph comprising social network participant IDs and social network connection information used by social network participants to access the limited offer. For example, computing device may store participant IDs of the root participants in the limited offer and participant IDs of the branch participants in the limited offer, including information indicating participants relied upon by each branch participant to qualify for the limited offer.

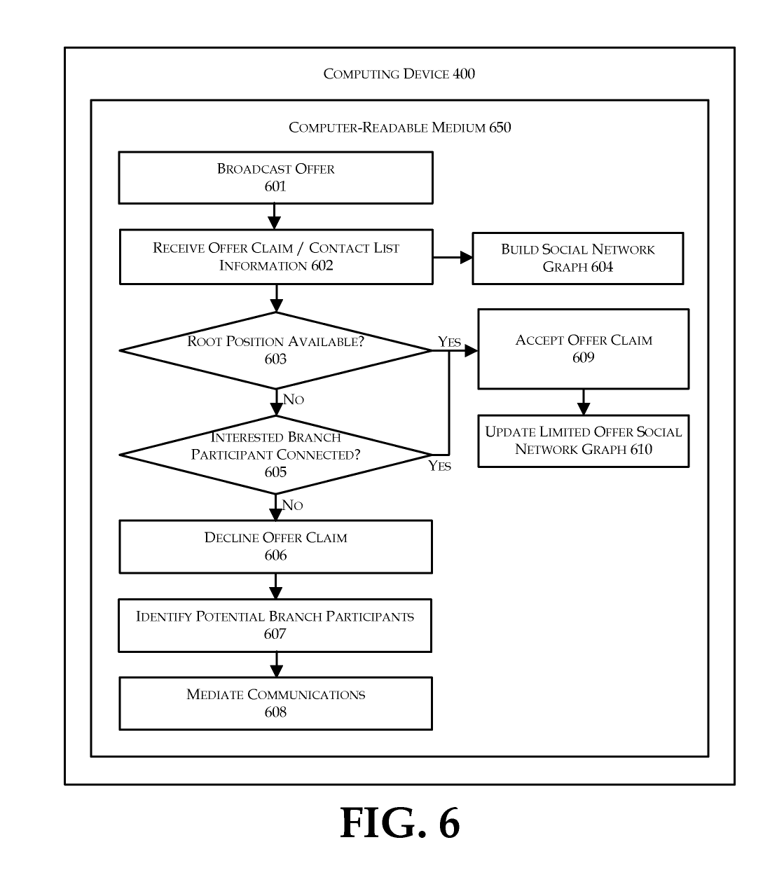

FIG. 6 is a flow diagram illustrating an example method configured to build a social network graph in connection with distributing limited offers using social network graph information, arranged in accordance with at least some embodiments of the present disclosure. FIG. 6 includes several elements which may be similar or identical to elements in FIG. 5, as described below, in addition to several additional elements which are unique to FIG. 6. The example flow diagram may include one or more operations/modules as illustrated by blocks 601-610, which represent operations as may be performed in a method, functional modules in a computing device 400 equipped with a limited offer distribution system such as illustrated in FIG. 4, and/or instructions as may be recorded on a computer readable medium 650. The illustrated blocks 601-610 may be arranged to provide functional operations of “Broadcast Offer” at block 601, “Receive Offer Claim/Contact List Information” at block 602, “Root Position Available?” at decision block 603, “Build Social Network Graph” at block 604, “Interested Branch Participant Connected?” at decision block 605, “Decline Offer Claim” at block 606, “Identify Potential Branch Participants” at block 607,” “Mediate Communications” at block 608, “Accept Offer Claim” at block 609, and “Update Limited Offer Social Network Graph” at block 610.

In FIG. 6, blocks 601-610 are illustrated as including blocks being performed sequentially, e.g., with block 601 first and block 610 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 6 illustrates an example method by which computing device 400 may build a social network graph in connection with distributing limited offers using social network graph information. Offers may be limited by limiting root participants, and determining whether to accept or decline offer claims from interested branch participants based on connections to other limited offer participants. Contact list information may be gathered from participants to build the social network graph as well as determine when participants qualify for the limited offer.

In a “Broadcast Offer” block 601, computing device 400 may make a limited offer available to any participants. Computing device 400 may for example use any of the techniques described above in connection with FIG. 5. Block 601 may be followed by block 602.

In a “Receive Offer Claim/Contact List Information” block 602, computing device 400 may receive an offer claim to the broadcast limited offer. Computing device 400 may receive the offer claim, as described above in connection with FIG. 5. The offer claim may include a participant ID, such as a participant name or social security number, and a limited offer ID. In some embodiments, computing device 400 may request contact list information in response to the offer claim, as a condition of participating in the limited offer. Contact list information may comprise, e.g., an email username and password for automated collection of email contacts, and/or any file or collection of files comprising participant contact list information. Computing device 400 may request contact list information for interested branch participants, root participants, or both. Block 602 may be followed by decision block 603 and block 604.

In a “Root Position Available?” decision block 603, computing device 400 may determine whether the received offer claim qualifies for a root position in the limited offer. Computing device 400 may use techniques described above in connection with FIG. 5. In some embodiments, rooting rules in connection with FIG. 6 may define that participants may provide contact list information in order to qualify as a root participant. In some embodiments, root participants need not be required to provide contact list information. Computing device 400 may access a social network graph built according to block 604 to determine connections between a potential root participant and other root and/or branch participants in the limited offer, when necessary under applicable rooting rules. Decision block 603 may be followed by decision block 605.

In a “Build Social Network Graph” block 604, computing device 400 may build and store a social network graph using received contact list information. Computing device 400 build and store the social network graph by performing graph write operations with received contact list information, for example, by comparing names and/or emails of contacts in received contact list information with names and/or emails in the social network graph, adding new participant IDs for contacts in social network graph when not already present, and including connection information connecting, in social network graph, contacts in received contact list information with a participant that submitted the contact list information. The participant that submitted the contact list information may also be added to the social network graph, if not already present therein. In some embodiments, root participants and/or branch participants may be flagged in the social network graph, to create a limited offer social network graph within the larger social network graph comprising contacts in addition to those who participated in the limited offer.

Computing device 600 may perform blocks 605, 606, and/or 609 to limit the limited offer to branch participants connected to root participants and/or other branch participants. In an “Interested Branch Participant Connected?” decision block 605, in some embodiments, computing device 400 may compare received contact list information to root participants and/or branch participants in the limited offer. In some embodiments, computing device 400 may determine whether the interested branch participant was identified in the social network graph built according to block 604, prior to the interested branch participant submitting the offer claim. Computing device 400 may thereby determine whether the interested branch participant associated with the received offer claim is connected to the root participants and/or other branch participants in the limited offer. When the interested branch participant is connected, the interested branch participant may qualify for the limited offer, and decision block 605 may be followed by block 609. When the interested branch participant is not connected, the interested branch participant may not qualify for the limited offer, and decision block 605 may be followed by block 606.

In embodiments comprising limited offers allowing indirect connections between participants, computing device 400 may evaluate whether any contacts in contact list information received in block 602 comprise contacts of root participants and/or branch participants in the social network graph. If true, the interested branch participant may be treated as connected and therefore qualifying for the limited offer, and decision block 605 may be followed by block 609. If false, the interested branch participant may be treated as not connected and therefore not qualifying for the limited offer, and decision block 605 may be followed by block 606.

In a “Decline Offer Claim” block 606, computing device 400 may decline the offer claim from the interested branch participant when the social network graph information indicates no connection between the interested branch participant and the root participants and/or branch participants in the limited offer. Declining the offer claim may for example comprise techniques described above in connection with FIG. 5. Block 606 may be followed by block 607.

In an “Identify Potential Branch Participants” block 607, when contacts in contact list information received in block 602 comprise contacts of root participants and/or branch participants in the social network graph, computing device 400 may identify, to the interested branch participant in response to the offer claim from the interested branch participant, the potential branch participants, e.g., the shared contact(s), linking the interested branch participant with the root participants and/or branch participants. Computing device 400 may employ techniques described above in connection with FIG. 5. Block 607 may be followed by block 608.

In a “Mediate Communications” block 608, in some embodiments computing device 400 may mediate a suggestion, by the interested branch participant to the one or more potential branch participants, to submit an offer claim to the limited offer. In some embodiments computing device 400 may mediate a connection request, by the interested branch participant to one or more of a root participant and/or a potential branch participant linking the interested branch participant with a root participant, to establish a connection in the social network. Computing device 400 may for example mediate suggestions by emailing potential branch participants using email information included in received contact list information, or otherwise contacting potential branch participants using information included in received contact list information. Computing device 400 may employ techniques described above in connection with FIG. 5. Blocks 607 and/or 608 may be followed by the interested branch participant submitting another offer claim, which may be received by block 602 and processed as described above.

In an “Accept Offer Claim” block 609, computing device 400 may accept an offer claim when a root position was determined to be available in decision block 603 and/or it was determined that an interested branch participant is connected in decision block 605 (e.g., when social network graph information indicates a connection between the interested branch participant and the root participants and/or branch participants in the limited offer). Computing device 400 may accept the offer claim for example using techniques described above in connection with FIG. 5. Block 609 may be followed by block 610.

In an “Update Limited Offer Social Network Graph” block 610, computing device 400 may store and update a limited offer social network graph comprising social network participant IDs and social network connection information used by social network participants to access the limited offer. In some embodiments, block 610 may be unnecessary where limited offer social network graph information is included in the social network graph built according to block 604. Other embodiments may store a limited offer social network graph separately from the social network graph built according to block 604.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely examples and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly inter-actable and/or wirelessly interacting components and/or logically interacting and/or logically inter-actable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method for distributing limited offers using social network graph information, comprising:
receiving and accepting, by a computing device, offer claims from one or more root participants, wherein the offer claims are in response to a broadcasted limited offer, and wherein the limited offer is available to limited root participants; and
limiting the limited offer to branch participants connected in a social network to the root participants and/or other branch participants in the limited offer, by performing, by the computing device in response to an offer claim from an interested branch participant, operations comprising:
providing an interested branch participant identifier (ID) to a social network interface;
receiving, from the social network interface, social network graph information indicating connections between the interested branch participant and the root participants and/or other branch participants in the limited offer;
accepting the offer claim from the interested branch participant when the social network graph information indicates a connection between the interested branch participant and at least one root participant and/or other branch participant in the limited offer; and
declining the offer claim from the interested branch participant when the social network graph information indicates no connection between the interested branch participant and the root participants or other branch participants in the limited offer.

2. The method of claim 1, wherein the social network graph information indicates a connection between the interested branch participant and a root participant or branch participant in the limited offer when the interested branch participant is equal to or less than a predefined number of connection steps apart from the root participant or branch participant in the social network graph, and wherein the social network graph information indicates no connection between the interested branch participant and the root participant or branch participant when the interested branch participant is greater than a predefined number of connection steps apart from the root participant or branch participant in the social network graph.

3. The method of claim 1, wherein the social network graph information indicates one or more potential branch participants linking the interested branch participant with a root participant or a branch participant in the limited offer, and further comprising identifying, to the interested branch participant in response to the offer claim from the interested branch participant, the potential branch participants linking the interested branch participant with the root participant or branch participant in the limited offer.

4. The method of claim 3, further comprising mediating a suggestion, by the interested branch participant to the one or more potential branch participants, to submit an offer claim to the limited offer.

5. The method of claim 1, further comprising mediating a connection request, by the interested branch participant to a root participant or a branch participant in the limited offer, to establish a connection in the social network which qualifies the interested branch participant for the limited offer.

6. The method of claim 1, further comprising storing a limited offer social network graph comprising social network participant IDs and social network connection information used by social network participants to access the limited offer.

7. The method of claim 1, wherein the root participants comprise participants in the social network who are first to submit an offer claim to a limited total number of seed offers.

8. The method of claim 1, wherein the root participants comprise participants in the social network who are at least a predefined number of connection steps apart in the social network graph from other root participants in the limited offer.

9. The method of claim 1, wherein the social network interface comprises an open graph API.

10. A non-transitory computer readable storage medium having computer executable instructions executable by a processor, the instructions that, when executed by the processor, implement a limited offer distribution system which causes the processor to:
receive and accept offer claims from one or more root participants, wherein the offer claims are in response to a broadcasted limited offer, and wherein the limited offer is available to limited root participants; and
limiting the limited offer to branch participants connected in a social network to the root participants and/or other branch participants in the limited offer, by performing, in response to an offer claim from an interested branch participant, operations comprising:
providing an interested branch participant identifier (ID) to a social network interface;
receiving, from the social network interface, social network graph information indicating connections between the interested branch participant and the root participants and/or other branch participants in the limited offer;
accepting the offer claim from the interested branch participant when the social network graph information indicates a connection between the interested branch participant and at least one root participant and/or other branch participant in the limited offer; and
declining the offer claim from the interested branch participant when the social network graph information indicates no connection between the interested branch participant and the root participants or other branch participants in the limited offer.

11. (canceled)

12. The non-transitory computer readable storage medium of claim 10, wherein the social network graph information indicates one or more potential branch participants linking the interested branch participant with a root participant or a branch participant in the limited offer, and wherein the instructions cause the processor to identify, to the interested branch participant in response to the offer claim from the interested branch participant, the potential branch participants linking the interested branch participant with the root participant or branch participant in the limited offer.

13. The non-transitory computer readable storage medium of claim 12, wherein the limited offer distribution system causes the processor to mediate a suggestion, by the interested branch participant to the one or more potential branch participants, to submit an offer claim to the limited offer.

14. (canceled)

15. The non-transitory computer readable storage medium of claim 10, wherein the limited offer distribution system causes the processor to store a limited offer social network graph comprising social network participant IDs and social network connection information used by social network participants to access the limited offer.

16. The non-transitory computer readable storage medium of claim 10, wherein the root participants comprise participants in the social network who are first to submit an offer claim to a limited total number of seed offers.

17-18. (canceled)

19. A computing device configured to provide a limited offer distribution system, comprising:
a processor;
a memory; and
a limited offer distribution system stored in the memory and executable by the processor, wherein the limited offer distribution system is configured to:
receive and accept offer claims from one or more root participants in a social network, wherein the offer claims are in response to a broadcasted limited offer, and wherein the limited offer is available to limited root participants; and
limit the limited offer to branch participants connected to the root participants in the social network, by performing, in response to an offer claim from an interested branch participant, operations comprising:
providing an interested branch participant identifier (ID) to a social network interface;
receiving, from the social network interface, social network graph information indicating connections between the interested branch participant and the root participants;
accepting the offer claim from the interested branch participant when the social network graph information indicates a connection between the interested branch participant and at least one root participant; and
declining the offer claim from the interested branch participant when the social network graph information indicates no connection between the interested branch participant and the root participants.

20. (canceled)

21. The computing device of claim 19, wherein the social network graph information indicates one or more potential branch participants linking the interested branch participant with a root participant or a branch participant in the limited offer, and wherein the limited offer distribution system is configured to identify, to the interested branch participant in response to the offer claim from the interested branch participant, the potential branch participants linking the interested branch participant with the root participant or branch participant in the limited offer.

22. (canceled)

23. The computing device of claim 19, wherein the limited offer distribution system is configured to mediate a connection request, by the interested branch participant to a root participant or a branch participant in the limited offer, to establish a connection in the social network which qualifies the interested branch participant for the limited offer.

24. The computing device of claim 19, wherein the limited offer distribution system is configured to store a limited offer social network graph comprising social network participant IDs and social network connection information used by social network participants to access the limited offer.

25. The computing device of claim 19, wherein the root participants comprise participants in the social network who are first to submit an offer claim to a limited total number of seed offers.

26. The computing device of claim 19, wherein the root participants comprise participants in the social network who are at least a predefined number of connection steps apart in the social network graph from other root participants in the limited offer.

27-51. (canceled)
